(19) United States
(12) Patent Application Publication
(10) Pub. No.: US 2026/0352961 A1
(43) Pub. Date: Nov. 5, 2026

(54) SYSTEM, SUBSYSTEM AND METHOD FOR SUPPRESSION OF SPECKLES IN IMAGING SYSTEM AND IMAGING SYSTEM USING TRANSMISSION SUBSYSTEM WITH SPECKLE SUPPRESSION ABILITIES

(71) Applicant: ELBIT SYSTEMS ELECTRO-OPTICS ELOP LTD., Rehovot (IL)

(72) Inventors: Doron CHOMSKY, Rehovot (IL); Ofer GAYER, Rehovot (IL)

(73) Assignee: ELBIT SYSTEMS ELECTRO-OPTICS ELOP LTD., Rehovot (IL)

(21) Appl. No.: 19/567,143

(22) Filed: Mar. 15, 2026

Related U.S. Application Data
(63) Continuation of application No. PCT/IL2024/050484, filed on May 16, 2024.

(30) Foreign Application Priority Data
Sep. 21, 2023 (IL) 307723

(51) Int. Cl. H04N 23/74; G02B 27/10

(52) U.S. Cl. CPC H04N 23/74; G02B 27/1066

(57) ABSTRACT

Systems, subsystems and methods for speckle suppression for an imaging system, that use: an illumination setup configured to emit light of a narrow wavelength bandwidth; and a number of wavelength (WL) converters, each configured to receive at least a portion of the light emitted by the illumination setup and convert spectral properties of the received at least portion of the light, to form an array of “n” number of spectrally differentiated input beams; and a spectral beam combining (SBC) setup configured for beam combining of the array of spectrally differentiated input beams emanating from the illumination setup, outputting a combined multispectral beam. The systems, subsystems and/or methods is/are configured to emit output light, for illuminating at least one surface of an area of interest (AOI) in a manner that causes speckle suppression and also mitigates spatial intensity distribution expansion affects caused due to the speckle suppression.

### CROSS REFERENCE TO RELATED APPLICATIONS

This Patent Application is a Continuation of PCT Application No. PCT/IL2024/050484, International filing date May 16, 2024, which claims the priority of Israel Patent Application No. 307723, filed on Sep. 21, 2023 which is incorporated herein by reference in its entirety;

### TECHNICAL FIELD

The present invention relates to the field of speckle suppression and more particularly to systems and methods with speckle suppression abilities for improved imaging of one or more objects/surfaces.

### BACKGROUND

Optical speckles noise can be defined as a granular (noise) texture appearing in an image of one or more imaged objects/surfaces, which usually degrades image quality related properties such as contrast and/or depth accuracy. Speckles often occur due to uneven or roughened surface(s) texture(s) or varying roughness/reflectance values between different surfaces of the object(s) to be imaged.

The speckle phenomena is known to further increase in cases in which the object(s) are irradiated with coherent light such as a laser beam.

One available solution for reducing speckles formed by an imagery that uses a coherent laser light source, by using spatial diversity techniques for creating multiple virtual light sources of similar spectral properties and varying optical path lengths can be taught from:

“Homogeneous and Speckle Free Laser Illumination for Range-Gated Imaging and Active Polarimetry” to Martine Laurenzis et al., French-German Institute of Saint Luis, Optical Engineering 51(6), 061302, June 2012; and

“Methodology for Conception of Speckle Reduction Elements in the Case of Short Pulse Illumination” to Yves Lutz et al., http://proceedings.spiedigitallibrary.org/on Feb. 15, 2016 Terms of Use: http://spiedigitallibrary.org/ss/TermsOfUse.aspx.

These articles/publications teach using one or more optical elements enabling speckle reduction by way of generating spatial diversity of multiple light sources of similar spectral properties using a single laser source of a single emission wavelength (WL) or narrow WL bandwidth, mainly by degrading beams coherency by forming multiple beams or beam parts of varying optical path lengths (OPLs) in respect to one another.

According to the above-described methods, and based on the Goodman's Theory of Speckles, when using a “M” (integer) number of light sources of spectral coherency yet OPL incoherency, the image contrast Cᵢₘ can be improved by a factor of up to √m (the square root of “m”), such that:

$$SC = \frac{SC 0}{√ M} , M > 1. \qquad ( 1 )$$

Assuming a “M” number of sources of identical optical properties such as identical emission WL and intensity, where SC is the image speckles contrast and SC₀ is an initial image speckle contrast before the speckle reduction/suppression.

However, the number “M” can be limited by one or more system-restrictions such as laser cavity length L_{c}, which consequentially limits the speckles reduction/suppression ability of the system.

Another technique for speckle suppression is using spectral diversity by illuminating the target or area of interest (AOI) with a light source of a wide spectral range or by generating a multiplicity of beams each of a different spectral property (emission WL). This technique is taught in “3D Imaging with Range Gated Laser Systems using Speckle Reduction Techniques to Improve the Depth Accuracy” to B. Johler et al., Research Institute of Optronics and Pattern Recognition, Electro-Optical and Infrared Systems: Technology and Applications V, edited by David A. Huckridge, Reinhard R. Ebert Proc. of SPIE Vol. 7113, 711307. © 2008 SPIE.

### SUMMARY

Aspects of disclosed embodiments pertain to a suppression subsystem for reducing speckles in an imagery system, the suppression subsystem comprising:
an illumination setup including:
at least one light source, each light source being configured to emit light of a narrow wavelength bandwidth;
a number of wavelength (WL) converters, each WL converter being configured to receive at least a portion of the light emitted by one of the at least one light source and convert spectral properties of the received at least portion of the light, wherein the WL converters are configured to form an array of “n” number of spectrally differentiated input beams; and
a spectral beam combining (SBC) setup configured for beam combining of the array of spectrally differentiated input beams emanating from the illumination setup, outputting a combined multispectral beam comprising multiple spectrally differentiated output beams propagated in parallel trajectories, where the suppression subsystem may be configured to emit output light therefrom, for illuminating at least one surface of an area of interest (AOI) in a manner that causes speckle suppression and also mitigates spatial intensity distribution expansion affects caused due to the speckle suppression.

According to some embodiments, the SBC setup includes:
an array of “n” number of collimators;
an optical setup comprising at least one element having at least one diffractive surface, configured for causing each of the received array of “n” number of spectrally differentiated input beams to be at least twice diffracted for combining the spectrally differentiated optical beams; or
a multiplicity of dichroic mirrors, each dichroic mirror being located and configured to receive input beam of a different WL “lₖ”, where “k” is an index number between l to n, and reflect the specific receivable input beam of WL lₖ and transmit therethrough at least all previously transmitted and reflected beams of WLs l₁ to lₖ₋₁, outputting a combined multispectral (MS) beam including WLs l₁ to lₙ.

According to some embodiments, each WL converter includes an Optical Parametric Oscillator (OPO) and/or a Raman parametric WL converter.

Each OPO may be configured to adjustably control WL of light being outputted thereby, based on temperature control.

According to some embodiments, the suppression subsystem may further include an angular diversity setup, configured and positioned to receive the generated combined multispectral beam from the SBC setup, and to form a multiplicity of virtual multispectral output sources formed over a virtual output surface, causing light from the multiplicity of virtual multispectral output sources to impinge the at least one surface of the AOI from different angles and at different wavelengths.

According to some embodiments, the angular diversity setup includes a guiding optical setup configured to directly or indirectly receive the combined multispectral beam from the SBC setup, and to form the set of virtual light sources, each virtual light source being steered to have a different angular propagation direction, outputting light of spectral and angular diversity.

According to some embodiments, the angular diversity setup further includes one or more of: a projection optical setup configured and positioned to reduce spatial expansion of the light emanating from the guiding optical setup; and/or an injection optical setup configured and positioned to receive the combined multispectral beam from the SBC setup, and to direct the received combined multispectral beam such as to pass through the guiding optical setup.

According to some embodiments, the guiding optical setup comprises one of: a bar-type homogenizer guide element; or two lenslet arrays positioned in parallel and at a distance “d” from one another having mutual focal lengths.

According to some embodiments, the bar-type homogenizer guide element has a rectangular or a trapezoid shape.

According to some embodiments, the distance “d” between the two lenslet arrays corresponds to the mutual focal length of the lenslet arrays.

According to some embodiments, the projection optical setup and/or the injection optical setup includes one or more focusing and/or collimation lenses.

According to some embodiments, the suppression subsystem further includes an optical path length (OPL) adjustment setup, configured and positioned to reduce mutual coherency by causing changes between optical path lengths (OPLs) of each beam portion of the at least one multispectral combined generated by the SBC setup.

According to some embodiments, the at least one light source of the illumination setup includes at least one of: a laser device, a light emitting diode, a laser element.

According to some embodiments, the at least one light source is an intra cavity or extra cavity second harmonics generation type laser device, outputting pulsed laser light within a narrow wavelength band.

According to some embodiments, the laser device is configured for outputting light within the visible wavelength band.

According to some embodiments, the laser device is configured to output pulsed light of a pulse duration that is higher than 50 nano seconds (ns).

Aspects of disclosed embodiments pertain to a method for reducing speckles in an imagery system, using a suppression subsystem the method including at least:
providing at least one light source, configured to emit light of a narrow wavelength bandwidth;
providing a number of WL converters, each WL converter being configured to convert spectral properties of received light;
at each WL converter:
receiving at least a portion of the light emitted by one of the at least one light source and converting spectral properties of the received at least portion of the light, where the WL converters are configured to form an array of “n” number of spectrally differentiated input beams;
receiving and beam combining of the array of spectrally differentiated input beams emanating from the WL converters, using a spectral beam combining (SBC) setup; and
outputting a combined multispectral beam comprising multiple spectrally differentiated output beams propagated in parallel trajectories, where the suppression subsystem is configured to emit output light therefrom, for illuminating at least one surface of an area of interest (AOI) in a manner that causes speckle suppression and also mitigates spatial intensity distribution expansion affects caused due to the speckle suppression.

According to some embodiments, the SBC setup includes:
an array of “n” number of collimators;
an optical setup comprising at least one element having at least one diffractive surface, configured for causing each of the received array of “n” number of spectrally differentiated input beams to be at least twice diffracted for combining the spectrally differentiated optical beams; or
a multiplicity of dichroic mirrors, each dichroic mirror being located and configured to receive input beam of a different WL “lₖ”, where “k” is an index number between l to n, reflect the specific WL lₖ of the received input beam and transmit therethrough at least all previously transmitted and reflected WLs l₁ to lₖ₋₁, outputting a combined MS beam including WLs l₁ to lₙ.

According to some embodiments, each WL converter includes an Optical Parametric Oscillator (OPO) and/or a Raman parametric WL converter.

Each OPO may be configured to adjustably control WL of light being outputted thereby, based on temperature control.

According to some embodiments, the method further includes:
receiving, by an angular diversity setup, the generated combined multispectral beam from the SBC setup; and
forming a multiplicity of virtual multispectral output sources formed over a virtual output surface, causing light from the multiplicity of virtual multispectral output sources to impinge the at least one surface of the AOI from different angles and at different wavelengths.

According to some embodiments, the angular diversity setup includes a guiding optical setup configured to directly or indirectly receive the combined multispectral beam from the SBC setup and form the set of virtual light sources, each virtual light source being steered to have a different angular propagation direction, outputting light of spectral and angular diversity.

According to some embodiments, the angular diversity setup further includes one or more of:
a projection optical setup configured and positioned to reduce spatial expansion of the light emanating from the guiding optical setup; and/or
an injection optical setup configured and positioned to receive the combined multispectral beam from the SBC setup and direct the received combined multispectral beam such as to be passed through the guiding optical setup.

According to some embodiments, the guiding optical setup includes one of: a bar-type homogenizer guide element; or two lenslet arrays positioned in parallel and at a distance D from one another having mutual focal lengths.

According to some embodiments, the projection optical setup and/or the injection optical setup includes one or more focusing and/or collimation lenses.

According to some embodiments, the method further includes causing changes between optical path lengths (OPLs) of each beam portion of the at least one multispectral combined generated by the SBC setup, using an OPL adjustment setup, for reducing mutual coherency of the beam portions.

According to some embodiments, the at least one light source of the illumination setup includes at least one of: a laser device, a light emitting diode, a laser element.

According to some embodiments, the at least one light source is an intra cavity or extra cavity second harmonics generation type laser device, outputting pulsed laser light within a narrow wavelength band.

According to some embodiments, the laser device is configured for outputting light within the visible wavelength band.

According to some embodiments, the laser device is configured to output pulsed light of a pulse duration that is higher than 50 nano seconds (ns).

### BRIEF DESCRIPTION OF THE DRAWINGS

In order to understand the presently disclosed subject matter and to see how it may be carried out in practice, the subject matter will now be described, by way of non-limiting examples only, with reference to the accompanying drawings, in which:

FIG. 1 is a block diagram, schematically illustrating a transmission subsystem that includes a suppression subsystem that is based on a combination of spectral and angular diversity for enhanced speckle suppression, in accordance with some disclosed embodiments;

FIG. 2 is a block diagram schematically illustrating an imaging system using the transmission subsystem of FIG. 1;

FIG. 3, schematically illustrated main components of an illumination subsystem of a transmission subsystem that uses a single light source and a multiplicity of oscillators for generating an array of spectrally differentiated optical beams for spectral diversity-based speckle suppression, according to some embodiments,

FIG. 4 schematically illustrates main components of a SBC setup used in a speckle suppression subsystem of a transmission subsystem of an imaging system that is based on spectral beam combining (SBC), according to some embodiments;

FIG. 5 schematically illustrates main components of a SBC setup used in a speckle suppression subsystem that uses a multiplicity of dichroic mirrors for generating a multi-spectral beam used for illuminating an area of interest, according to other embodiments;

FIGS. 6A and 6B show an angular diversity setup for speckle suppression, according to some embodiments: FIG. 6A show main components of the angular diversity setup; and FIG. 6A shows a schematic illustration of the beams paths when passed through optical elements of the angular diversity setup;

FIGS. 7A, 7B and 7C schematically illustrate various designs of the angular diversity setup, according to various embodiments thereof: FIG. 7A illustrates an angular diversity setup that includes a bar type homogenizer guide element; FIG. 7B illustrates an angular diversity setup that includes a wedge type homogenizer guide element; and FIG. 7C shows an angular diversity setup that uses two parallel lenslet arrays with same focal lengths, located at a distance from one another that corresponds to their focal length;

FIG. 8 shows a transmission subsystem having a speckle suppression subsystem which combines spectral and angular diversity and also uses optical path lengths adjustment, according to other embodiments;

FIG. 9 is a flowchart, schematically illustrating main steps of a method for speckle suppression, according to some embodiments;

FIG. 10 is a flowchart, schematically illustrating main steps of a method for speckle suppression based on SBC that is achieved by using a single light source of a narrow wavelength bandwidth; and

FIG. 11 is a flowchart, schematically illustrating general main steps a method for speckle suppression by spectral diversity, according to some embodiments.

### DETAILED DESCRIPTION OF EMBODIMENTS

In the following detailed description, various specific details are set forth in order to provide a thorough understanding of the presently disclosed subject matter. However, it will be understood by those skilled in the art that the presently disclosed subject matter may be practiced without these specific details and in various other manners. Speckle suppression for imaging of one or more surfaces of an area of interest (AOI), using one or more illumination sources for illuminating the AOI to be imaged, can be done by increasing spectral, polarization and/or angular diversity of light projected onto the target or the at least one surface of the AOI to be imaged by the imagery system. However, the increasing of spectral and/or angular diversity of the irradiated light, causes the irradiated light to quickly over-expand (e.g., over-disperse and/or over-diverge), thereby dramatically reducing the power/intensity spatial distribution of the irradiated light, which severely limits the distance from the illumination source to the target/AOI for enabling the proper or required illumination for the actual imaging of the at least one surface of the AOI.

Aspects of disclosed embodiments, pertain to subsystems, systems and methods for speckle suppression for an imaging system, that aim to enable a satisfactory/required speckle suppression while maintaining a required spatial intensity/power distribution that enables illumination of one or more surfaces of an AOI also located at far field (FF) traversing planes, in respect to the illumination source and/or diffraction limit of the illumination and/or speckle suppression setups, by mitigating intensity distribution expansion effects caused due to the speckle suppression.

Aspects of disclosed embodiments pertain to a speckle suppression subsystem that combines at least one speckle suppression means and/or technique (such as spectral diversity and/or angular diversity means and/or technique) with at least one means and/or technique for reducing spatial intensity distribution expansion of the light ultimately emitted by the speckle suppression subsystem for irradiating one or more surfaces of an AOI, mainly for mitigating emitted light's spatial expansion effects caused due to the speckle suppression, while still maintaining a satisfactory speckle suppression.

In some embodiments at least one of the speckle suppression properties may be adjustable for enabling, for instance, reducing speckle suppression for surfaces that less require such suppression for improving reduction of spatial intensity distribution of the emitted light and vice versa.

According to some embodiments, there is provided a suppression subsystem for reducing speckles in an imagery system, the suppression subsystem comprising at least:
an illumination setup comprising:
   at least one light source, each light source being configured to emit light of a narrow wavelength bandwidth; and
   a number of WL converters, each WL converter being configured to receive at least a portion of the light emitted by one of the at least one light source and convert spectral properties of the received at least portion of the light, wherein the WL converters are configured to form an array of “n” number of spectrally differentiated input beams; and
a SBC setup configured for spectral beam combining (SBC) of the array of spectrally differentiated input beams emanating from the illumination setup.

The suppression subsystem may be configured to emit output light therefrom, for irradiating at least one surface of an area of interest (AOI) in a manner that causes speckle suppression and also mitigates spatial intensity distribution expansion effects caused due to the speckle suppression at least in a far field traversing plane.

Aspects of disclosed embodiments pertain to systems, subsystems and methods for speckle suppression and systems and methods for imaging using speckle suppression means, based at least on illumination of a target/AOI including for example, illumination of one or more objects/targets of one or more surfaces, with a multi-spectral illumination/beam(s) such that the target/AOI is illuminated by multiple wavelengths from l to m, “m” being an integer number larger than 1, where the speckle suppression is also done while maintaining a required reduced spatial intensity/power distribution.

According to some embodiments, the speckle suppression may use a combination of spectral diversity and angular diversity such that a multi-spectral (MS) beam may be generated and then angular diversity may be formed, before outputted from the transmission subsystem for illumination of one or more targets or surfaces in an area of interest (AOI), such that the AOI is illuminated with a spectrally and angularly diverse illumination/beam.

This means that embodiments of the invention aim to both reduce the temporal coherency of the illumination of the AOI as well as to increase its angular diversity, such that each beam, outputted from the transmission subsystem impinges a surface or a spot at a different angular direction and at a different WL.

Using “n” number of different WLs is estimated to reduce speckles contrast C_{sc} by a factor of up to 1/\sqrt{n} Using angular diversity generating a “m” number of different angles is estimated to reduce speckles contrast C_{sc} by a factor of up to 1/\sqrt{m}.

Therefore, combining spectral diversity along with angular diversity may improve speckles suppression by reducing the speckles contrast C_{sc} by a factor of up to {1/\sqrt{n}. 1/\sqrt{m}}.

In other embodiments, the spectral diversity may be implemented for speckle suppression, using an illumination beam of a “n” number of WLs o l₁ to lₙ, for example, by using one illumination source of a same emission WL or WL narrow bandwidth and causing the single illumination source to be converted by conversion means to one or more multi-spectral sources illuminating the AOI or by using multiple spectrally differentiated light sources.

In some embodiments the speckle suppression may only include spectral diversity, without necessarily being combined with any one or more angular diversity based suppression means and/or techniques.

Additionally or alternatively, the spectral and angular diversity may be achieved simultaneously by using, for example, multiple MS light sources, each emanating from a different location for causing the angular diversity of the light used for illumination of the object(s) located at the AOI.

Whether the speckle suppression is only performed by spectral diversity and/or by angular diversity, the disclosed speckle suppression systems, subsystems and/or methods can be implemented such that the spectral and/or angular diversity is done in a manner that also enables maintaining a required spatial intensity/power distribution of the illuminated light for required distances between the illumination source(s) and the target/AOI to be imaged.

According to some embodiments, the transmission subsystem may include, for example: (i) an illumination subsystem configured for generating an array of input beams, each input beam being spectrally differentiated from another; and (ii) a suppression subsystem configured at least for suppression of speckles in the imaging system.

According to some embodiments, the suppression subsystem includes at least:
a spectral beam combining (SBC) setup configured to receive and beam-combine the generated array of input beams from the illumination subsystem and output a multi-spectral (MS) combined beam; and
an angular diversity setup configured and positioned to receive the multi-spectral combined beam from the SBC setup and form a multiplicity of virtual MS output sources formed over a virtual output surface, for reducing speckles in imaging of each of one or more surfaces illuminated by the transmission subsystem and located at a far field (FF) FF area, in respect to a location of the transmission subsystem, by causing light from the multiplicity of virtual MS output sources to impinge the one or more surfaces from different angles and at different wavelengths.

The angular diversity setup may also be configured to reduce mutual coherency between the multiplicity of virtual MS output sources.

Using a spectral beam combining (SBC) for the speckle suppression for the imagery system enables reducing spatial intensity/power distribution for maintaining a low spatial intensity/power distribution over long distances.

According to some embodiments, the illumination subsystem may use a single light source of a wide spectral bandwidth, a multiplicity of light sources each emitting light at a different WL or a different narrow WL bandwidth.

For example, a single light source can be used of a narrow emission WL bandwidth of an initial WL o, where each portion of the light emitted by the light source may be converted such as to emit a different WL than that of another portion, thereby generating an array of input beams of disrupted temporal coherency.

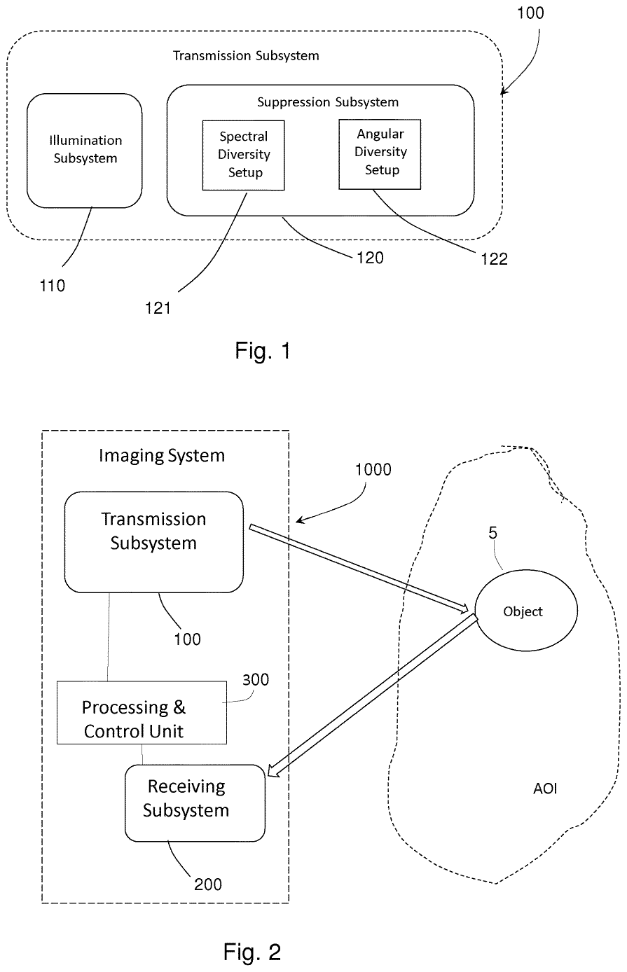

Reference is now made to FIG. 1, schematically illustrating a transmission subsystem 100 for an imaging system that uses the combined SBC and angular diversity technique, for speckle suppression. The transmission subsystem 100 may include at least:
an illumination subsystem 110, including at least one light source configured for generating at least one input beam; and
a suppression subsystem 120 that includes:
a SBC setup 121 configured to generate at least one multi-spectral (MS) beam; and
an angular diversity setup 122 configured and positioned to receive the MS beam outputted from the SBC setup and form a multiplicity of virtual MS output sources formed over a virtual output surface, for reducing speckles in imaging of one or more surfaces (e.g., of one or more objects or targets) in an area of interest (AOI) illuminated by the transmission subsystem 100 and located at a far field (FF) FF area, in respect to a location of the transmission subsystem 100, by causing light from the multiplicity of virtual MS output sources to impinge the one or more surfaces from different angles and at different wavelengths.

According to some embodiments, one or more diffractive means may be used by the SBC setup for generating the at least one MS beam, requiring that an input surface/port of the angular diversity setup will be located at a distance that is equal to or larger than a diffraction limit Lai of the SBC setup, i.e., a distance that is equal to or larger than a value that is proportional to the longest wavelength of the spectrum being outputted by the SBC setup.

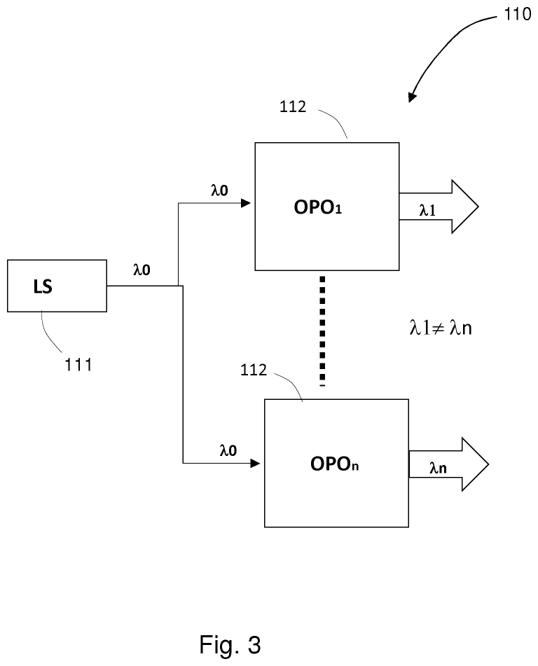

FIG. 2 illustrates an imaging system 1000 that includes at least:
the transmission subsystem 100 of FIG. 1; and
a receiving subsystem 200 for receiving imagery data from an area of interest (AOI) relating to one or more surfaces of one or more targets/objects such as object 5, by using one or more optical sensors and/or detectors including at least one optical detector such as a camera configured to detect light in one or more optical spectral ranges such as in the infrared (IR) and/or the visible (VIS) ranges.

According to some embodiments, the imaging system 1000 may be operatively associated with one or more processing and/or control units that may be embedded in the imaging system 1000 and/or external thereto, such as embedded processing and processing and control unit 300 shown in FIG. 2.

According to some embodiments, the processing and control unit 300 may be configured at least to receive sensor data from the one or more sensors of the receiving subsystem 200 and optionally also to analyze the received sensor data. Additionally or alternatively, the processing and control unit 300 may be configured to control the transmission subsystem, based on analysis of received sensor data.

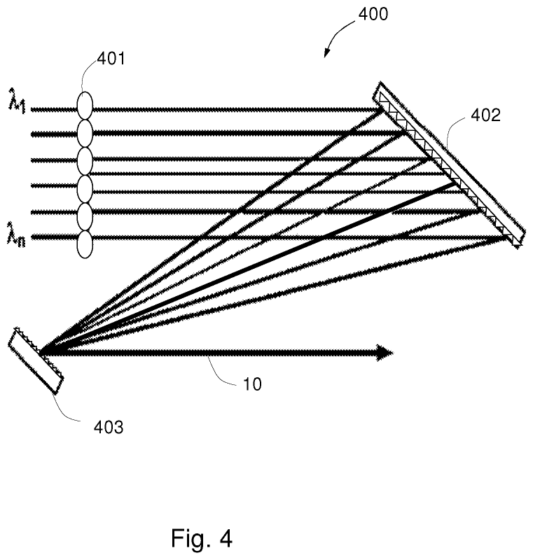

Reference is now made to FIG. 3, schematically illustrating one implementation of the illumination subsystem 110, according to some embodiments. The illumination subsystem 110 may include:
a single light source 111 configured to output light of a narrow wavelength (WL) bandwidth of main WL o; and
a set of an “n” number of WL converters, “n” being an integer number larger than l, each WL converter “i” 112 being configured to receive a portion of the light outputted by the single light source 111 and shift emission WL from the main WL □₀ by a predefined desired wavelength shift □□i of a value associated with the specific “i” WL converter, such as to form an array of spectrally differentiated input beams of different WLs: □₁ to □ₙ.

According to some embodiments, each WL converter 112 may include a separate singly resonant optical parametric oscillator (OPO) device. In some embodiments each OPO may be configured to control WL being outputted thereby, based on temperature control. The OPOs may enable modes suppression/filtering resulting in an output beam of a high beam quality of high coherency.

According to other embodiments, each WL converter may include a Raman parametric WL converter using fiber Bragg gratings also enabling adjustable outputting output beam of high beam quality and modes filtration/suppression.

For example, Raman fiber laser may be used for each of the WL converters. A source pumping laser for the Raman converter is Ytterbium silica fiber laser, where its emitting WL value can be tuned/adjust in the range of 1040-1100 nm in the spectral domain. The pump laser is spliced to Raman laser which is usually double clad Germanium glass fiber and two Bragg gratings for intra-cavity reflections. The Raman fiber enables adjustment of the wavelength of the light emitted therefrom, by the Raman shift. The process can be implemented to higher order Stokes shifts, for example, as described in Lei Zhang, 1,2 Chi Liu, 1 Huawei Jiang, 1,2 Yunfeng Qil, Bing He, 1 June Zhou, 1,4 Xijia Gu,3 and Yan Feng1, “Kilowatt Ytterbium-Raman fiber laser”, Optical Society of America, 2014, Vol. 22, No. 15|DOI: 10.1364/OE.22.018483|OPTICS EXPRESS, Pages 18483-18489.

Spectral beam combing of several Raman fiber lasers can also be used as the spectral diversify setup for speckle suppression, with good beam quality to mitigate the spatial illumination expansion on the target.

The light source 111 of the illumination subsystem 110 may include a laser device, a light emitting diode, or a laser element. According to some embodiments, the light source 111 may include a laser device based on a frequency doubled Nd: YLF/YAG oscillator using a Q-switch, with intra cavity or extra cavity second harmonics generation, outputting pulsed laser light e.g., in the visible (VIS) range such as in the green range of a wide pulse duration such as (yet not limited to) a pulse duration that is over 50 nano seconds (ns) preferably between 100-120 ns.

According to some embodiments, the illumination subsystem 110 may additionally include one or more optical elements and/or devices for splitting light outputted by the single light source 111 into an array of beams of same one or more optical properties such as emission WL, intensity, flux, spatial energy distribution (profile), etc. and directing each beam to be received by its corresponding WL converter 112.

The illumination subsystem 110 in this case, will output an array of input beams to be fed into the SBC setup 121 of the transmission subsystem 100 including, for example a SBC setup for combining the array of the (spectrally differentiated) output beams outputted from the illumination subsystem 110 for reducing spatial expansion of the beams enabling thereby illumination of distant targets/AOIs located at FF traversing planes, in respect to the source of illumination and/or in respect to the diffraction limit of the SBC setup. The SBC setup 121 may be configured for limiting/reducing spatial expansion of the input beams emanating from the illumination subsystem 110, inter alia, by reducing spot size (in relation to the overall intensity/power distribution of the input beams) and increasing spatial coherency of the combined beam, while maintaining high beam quality of the combined beam outputted by the SBC setup 121 over large distances for enabling high quality illumination and therefore imaging of the AOI or surface(s) thereof.

Since the WL converters 112 output input beams of high beam quality, the SBC setup 121 may be located at the diffraction limit of the WL converters 112 to preserve and further enhance beam quality, while reducing spot size and spatial expansion of the incoming input beams, emanating from the WL converters 112.

According to some embodiments, the SBC setup may use at least one diffractive mask and may be configured for multiple-diffraction of each of the input beams passed therethrough.

One implementation of a multi-diffraction SBC is by using two separate diffraction grating (DG) elements each DG element has a DG mask embossed and/or imprinted over one surface thereof.

In one particular example, the light source 111 may include an intra-cavity second harmonics Nd: YAG/YLF Q-switched laser of energy of between 10-100 mJ/pulse. SHG crystal preferably NCPM LBO also KTP or BBO can be implemented, having a typical pulse duration of about ~100 nsec.

In some embodiments, the output wavelength of the WL converter 112 signal may be tunable by adjusting the crystal temperature thereby controlling emitted WL of the outputted light.

According to some embodiments the spectral range of each WL converter 112 may be between 750-920 nm (nanometers), e.g., using singly resonant OPO such as NCPM LBO, KTP, or BBO, achieving by pump long pulse width near diffraction limit (DL) thereby maintaining high beam quality.

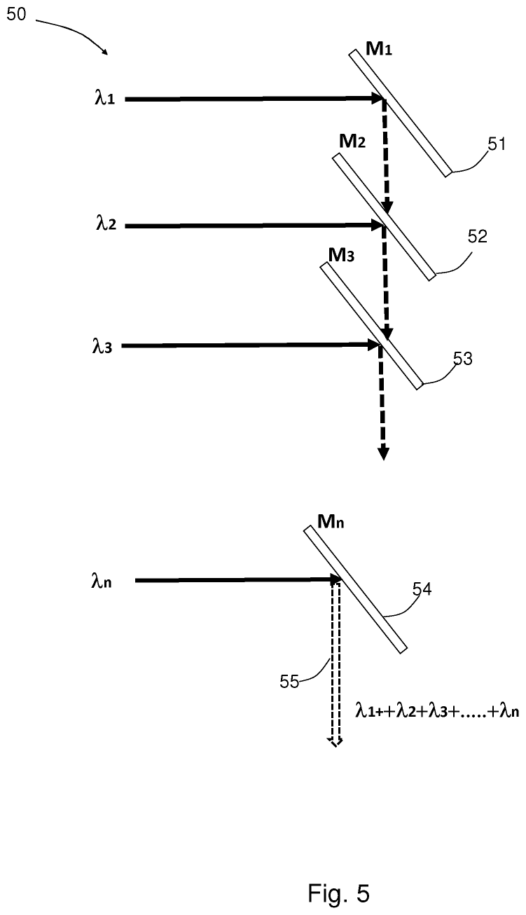

FIG. 4 schematically illustrates main components of a double-grating SBC setup 400 used in a speckle suppression subsystem of a transmission subsystem, according to some embodiments. The SBC setup 400 may include:
a lenslet array 401 including an array of collimating lenses configured to receive an array of spectrally differentiated input beams from the illumination subsystem and collimate each received input beam;
a first DG element 402; and
a second DG element 403 located at a distance from the first DG element 402.

The first DG element 402 may be positioned and configured such as to redirect each incoming beam, outputted from the lenslet array 401, by changing its propagation direction such that all beams will be diverted to converge (e.g., by being focused) to a single point or spot over the second DG element 403, where the second DG element 403 may be configured and positioned to have all the beams converged thereover as well as to combine the beams by causing them to all propagate in parallel to one another yet at a much more dense manner and optionally also by changing the overall spatial distribution thereof and/or of each beam in separate, outputting a MS combined beam 10.

Using OPO converters for converting the WL of each portion of the light emanating from a single light source may also reduce spatial expansion of the beams as they exit the OPOs and as they are further directed and enter the SBC setup, further improving the actual beam combining.

Any other implementation of the SBC setup may be used such as implementations that include using a single monolithic element including at least one diffractive mask thereover such as SBC devices disclosed in WO 2020/174461 A1 to Schiffer Zeev et al. (Elbit Systems Electro-Optics, Ltd.), which is incorporated herein by reference in its entirety.

The total combined beam may be composed of diversity of wavelengths and near DL beam quality, which facilitates and/or enhances the implementation of angular diversity.

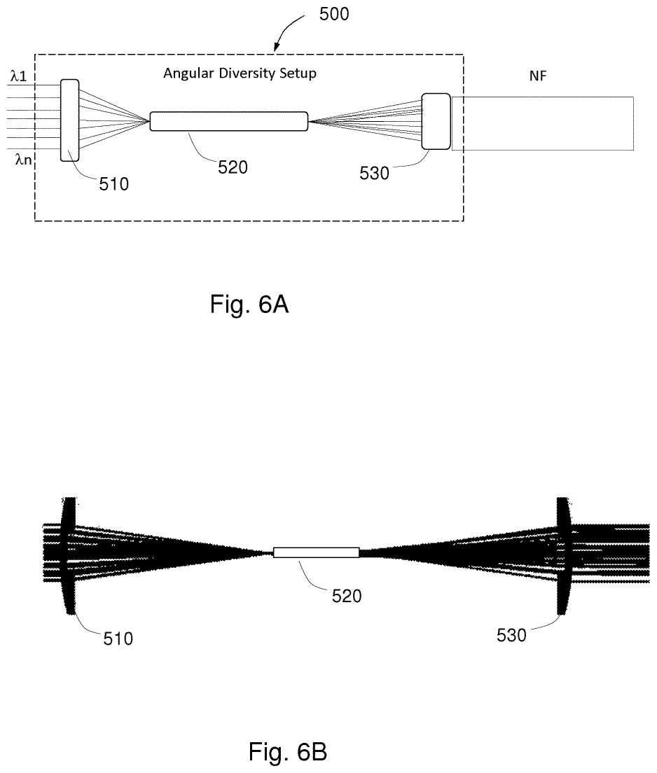

FIG. 5 schematically illustrates a different manner in which spectral diversity can be obtained by the SBC setup 121 by using an array 50 of an “n” number of dichroic mirrors 51-54, each being located and configured to receive input beam of a different WL “lₖ”, where “k” is an index number between l to n, and reflect the specific receivable WL lₖ while transmitting therethrough at least all previously transmitted WLs. The output of such dichroic mirrors 51-54 array is a MS beam 55 preferably of a relatively small aperture and optionally also of a long spatial coherency.

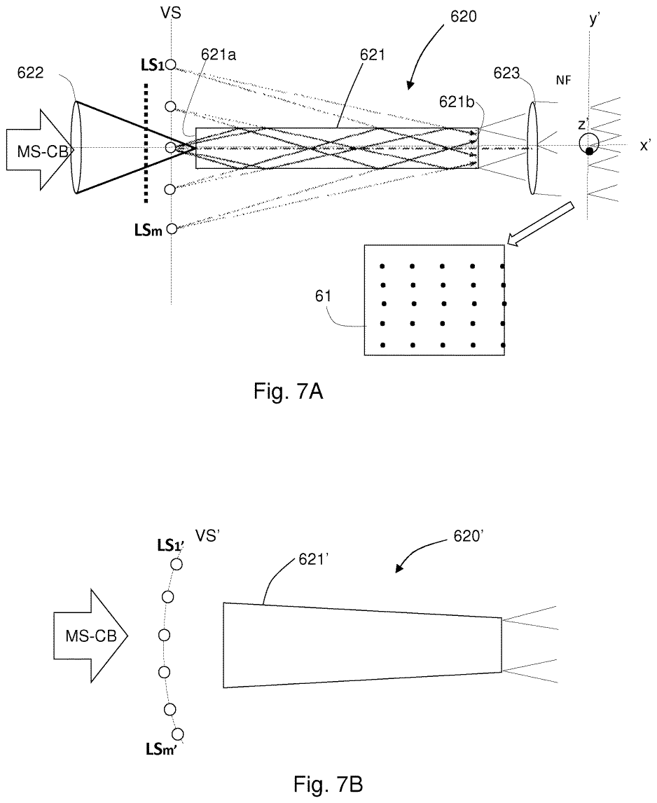

FIGS. 6A and 6B show an angular diversity setup 500 for speckle suppression, according to some embodiments, using an injection optical setup 510 configured to receive thereby the MS combined beam from the SBC setup 100/400 and direct the received MS combined beam such as to be passed through a guiding optical setup 520 also part of the angular diversity setup 500. The guiding optical setup 520 may be configure to have different parts of the received MS combined beam to be directed through a different optical path within the guiding optical setup 520 such as to form a set of virtual light sources, each virtual light source being steered to have a different angular propagation direction at a far field (FF) traversing plane or area, in respect to the location of the transmission subsystem by which the angular diversity setup 500 is used, such that each beam formed at a FF location impinges a same spot over a surface imaged by the imagery system at a different angle and a different WL, dramatically improving speckle suppression of the imagery of that surface and contrast between the surface and other nearby surface(s).

According to some embodiments, the angular diversity setup 500 may further include a projection optical setup 530 such as a focusing or collimation lens, configured to limit or reduce spatial expansion of the light emanating from the guiding optical setup 520.

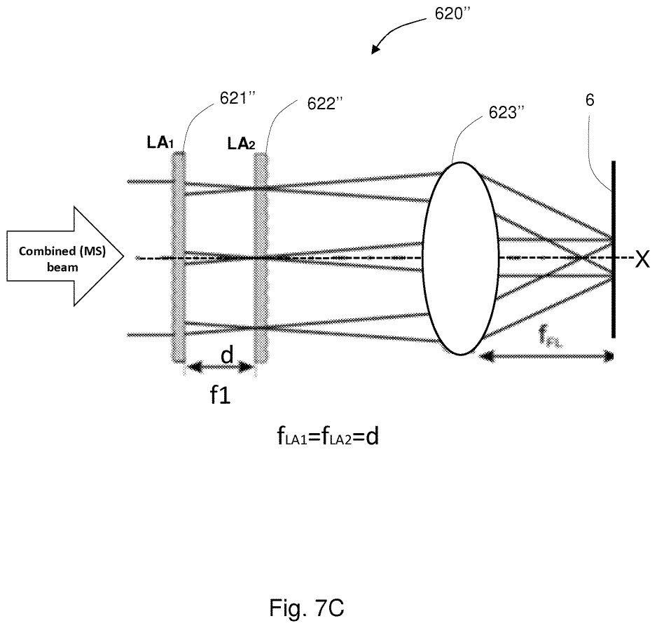

FIGS. 7A, 7B and 7C schematically illustrate various designs and components of the angular diversity setup 500, according to various embodiments thereof.

FIG. 7A illustrates an angular diversity setup 620 that includes a bar type homogenizer guide element 621, having a rectangular cross-sectional shape. The guide element 621 is configured for total or partial internal reflection of the MS combined beam (MS-CB) passed therethrough, such that the angle of entrance of each WL beam of the MS-CB is different from another (enabled by using one or more optical elements such as focusing lens 622 and/or a collimator positioned before an entrance surface 621a of the guide element 621). The diversity in angle of entrance of the different beams forces that each beam is directed through a different optical path, also causing a divergence in the overall optical path length (OPL) of each beam further disturbing spatial and time coherency. Another optical setup of one or more optical elements such as lens 623 may be used to reduce spatial expansion of the overall light emanating from an exit surface 621b of the guide element 621. The internal reflectivity of the guide element 621 and the causing of multiple beams to travel through different OPLs, generates multiple virtual light sources LS₁ to LSₘ, “m” being an integer number larger than 1, that appear to emanate from a single flat virtual surface VS that is parallel to a ZY plane perpendicular to an optical axis X, as shown in FIG. 7A.

As further shown in FIG. 7A, the bar-type angular diversity generates an array of corresponding light spots 61 at a traversing plane also perpendicular to the optical axis.

The guide element 621 creates multiple virtual laser point sources LS₁ to LSₘ, which have diverse transverse locations in the projection lens focal plan (see image of light spots 61). The transverse diversity is translated to angular diversity in the far field (FF) of the projection lens of the projection optical setup 530. The angular deviation of each consecutive source may be given by ΔS/f, where ΔS is each source transverse deviation from the adjacent one, and f is the projection lens focal length.

FIG. 7B illustrates an angular diversity setup 620′ that includes a wedge type homogenizer guide element 621′ having a trapezoid cross-sectional shape, configured and position to generate multiple virtual light sources LS₁′ to LSₘ′ positioned over a curved (e.g., spherical/semi-spherical) virtual surface VS′.

FIG. 7C shows an angular diversity setup 620″ that uses two parallel lenslet arrays: a first lenslet array 621″ and a second lenslet array 622″, located at a distance “d” from one another that corresponds to their mutual focal length f1.

In this case, the focal length f_{LA1} of each lens in the first lenslet Array 621″ is equal to the focal length f_{LA2} of each lens in the second lenslet Array 622″, both of which are equal to distance “d” such that: f_{LA1}=f_{LA2}=d. This causes a similar back and forth reflection of the entering beams (which are beam parts of the MS-CB outputted from the SBC setup of the suppression subsystem), where the outputted beam are converged by an optical element such as lens 623″ of a different focal length f_{FL}, generating thereby an array of virtual light sources over a plane 6 that is perpendicular to the optical axis X.

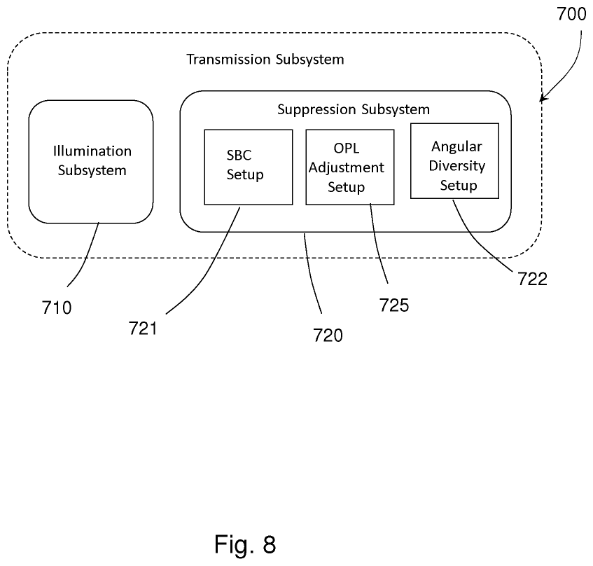

FIG. 8 shows a block diagram, schematically illustrating a transmission subsystem 700 for illumination of an AOI having speckles and fringes suppression abilities, according to other embodiments. The transmission subsystem 700 may include:
an illumination subsystem 710 configured for generating an array of input beams, each input beam being spectrally differentiated from another; and
a suppression subsystem 720 that includes:
a spectral beam combining (SBC) setup 721 configured to receive and beam-combine the generated array of input beams from the illumination subsystem and output a multi-spectral (MS) combined beam;
an optical path length (OPL) adjustment setup 725; and
an angular diversity setup 722, which may be configured in a similar manner to the angular diversity setup 500 of FIG. 6A.

According to some embodiments, the OPL adjustment setup 725 may be located before or after an injection or a projection optical setup of the angular diversity setup 722 or before the SBC setup 721 and include one or more optical elements and/or devices, such as a stepper optical element, located and configured to change each beam or beam portion passed through each different part thereof, such as to be directed through a different OPL, to further increase mutual incoherency of the virtual MS light sources formed.

The OPL adjustment setup 725 may be designed for a specific OPL adjustment implemented as a set of one or more non-tunable optical elements such as a stepper optical element, or implemented as a tunable/controllable OPL adjustor enabling separate tunable/controllable adjustment per each beam portion.

In some embodiments, the OPL of each beam or beam part may be adjustably changes creating OPL differences between the beams, e.g., by adjustably increasing or decreasing OPL differences between the beams/beam parts by a predetermined OPL difference □OPLj, “j” being an integer number between l to m and “m” being an integer number representing the maximal number of virtual light sources formed by the angular diversity setup 722. The OPL differences of each pair of adjacent beams of two adjacent virtual light sources may be gradually increased/decreased such that, for example |□OPLj-□□OPLj-1|=□, where “□” is a constant having a preset value.

According to some embodiments, in cases in which the OPL adjustment is done to the MS combined beam outputted from the SBC setup 721 and before the MS combined beam enters the angular diversity setup 722, each portion of the MS combined beam may have a different WL and the OPL adjustment setup 725 may be located and configured such as to adjust each beam portion of the MS combined beam, meaning each different WL for passing through a different OPL, e.g., by adding or reducing the beam portion's OPL.

According to some embodiments, the light source(s) of the illumination subsystem 110/710 may be configured for pulsed illumination and/or for gated or active imaging for improving depth of field (DoF) imaging and/or control.

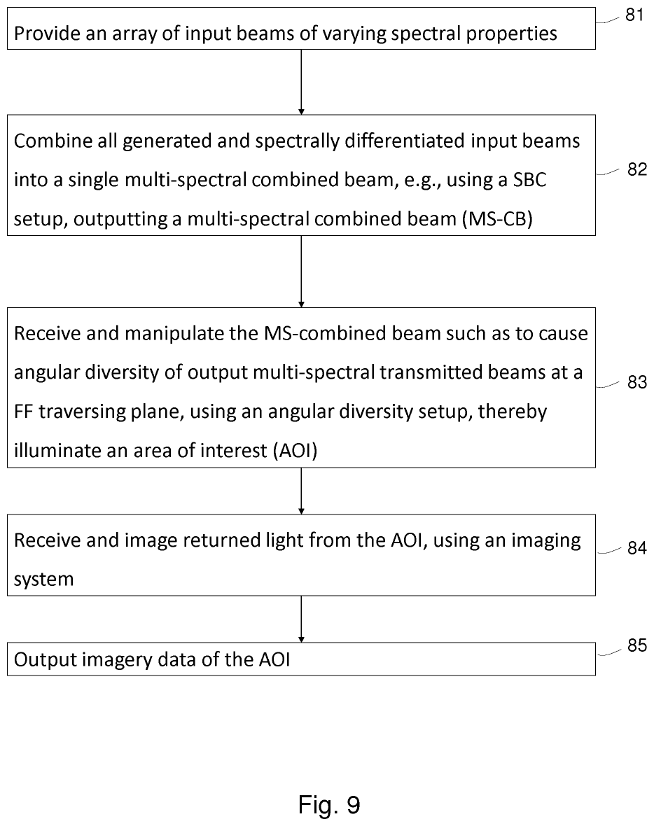

FIG. 9 is a flowchart, schematically illustrating main steps of a method for speckle suppression, according to some embodiments, using a transmission subsystem. This method includes at least the following main steps:
providing an array of input beams of varying spectral properties (step 81);
combining all generated and spectrally differentiated input beams into a single multi-spectral combined beam, e.g., using a SBC setup outputting a multi-spectral combined beam (MS-CB) (step 82), for reducing overall spot size of the combined multispectral beam (in respect to the overall spot size of the entering beams) and increasing spatial coherency and
(optional) receiving and manipulating the multi-spectral combined beam, using an angular diversity setup, such as to cause angular diversity of output light, outputted from the suppression subsystem, (step 83).

The spectrally diverse and optionally also angularly diverse output light may be outputted from the suppression setup in a manner that maintains a limited spatial expansion of that output light, for maintaining a required spatial intensity/power distribution of the output light.

This method may additionally include the steps of:
receiving and imaging returned light from the AOI, using a receiving system (step 84); and
outputting imagery data of the AOI (step 85).

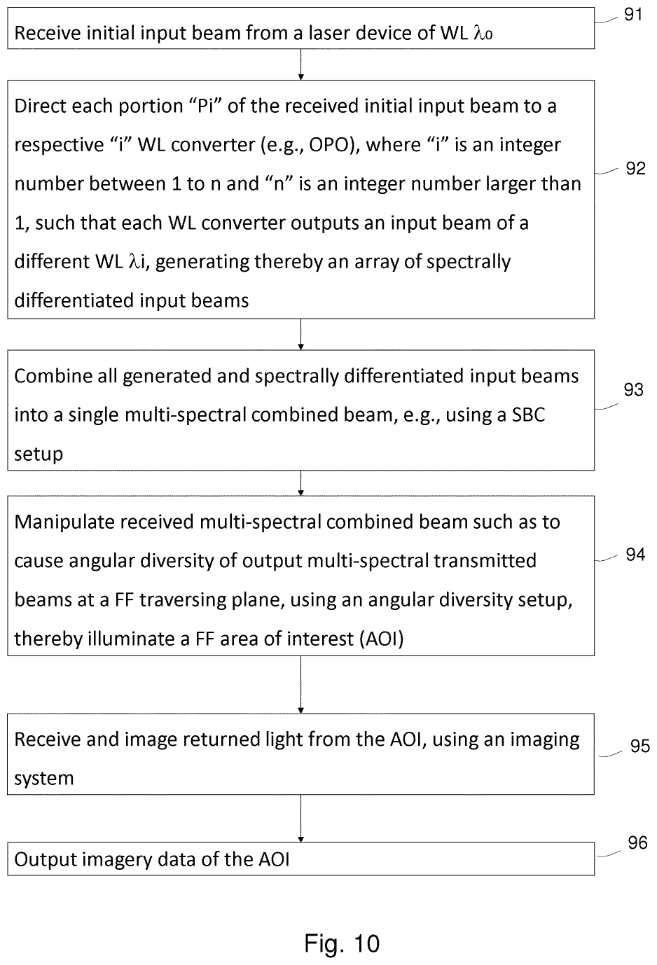

FIG. 10 is a flowchart, schematically illustrating main steps of a method for speckle suppression using a transmission subsystem with a single light source of a narrow wavelength bandwidth for obtaining an array of spectrally differentiated input beams. This method may include the following main steps:
receiving initial input beam from a laser device of a main output WL □₀ (step 91);
directing each portion “Pi” of the received initial input beam to a respective “i” WL converter (e.g., OPO), where “i” is an integer number between l to n and “n” is an integer number larger than 1, such that each WL converter outputs an input beam of a different WL □i, i−1 . . . n, generating thereby an array of spectrally differentiated input beams (Step 92);
combining the array of spectrally differentiated input beams into a single multi-spectral combined beam (MS-CB), e.g., using a SBC setup (Step 93); and
(optional) manipulating the multi-spectral combined beam, using an angular diversity setup, such as to cause angular diversity of output light, outputted from the suppression subsystem, (step 94).

The spectrally diverse and optionally also angularly diverse output light may be outputted from the suppression setup in a manner that maintains a limited spatial expansion of that output light, for maintaining a required spatial intensity/power distribution of the output light.

The method may also include the following additional steps:
receiving and imaging returned light from an area of interest (AOI) located in a FF area in respect to the transmission subsystem, using a receiving system (step 95); and
outputting imagery data of the AOI (step 96).

The array of spectrally differentiated input optical beams may be directed to imping an entrance surface or one or more input ports of the SBC setup using one or more optical means (Not Shown) such as via a corresponding array of optical fibers connected (e.g., by splicing) to the entrance surface/ports of the SBS setup.

In some cases, the input optical beams may be directed to enter the SBC setup such that their trajectories (propagation directions) are parallel to one another defining thereby an optical axis parallel to their (parallel) trajectories.

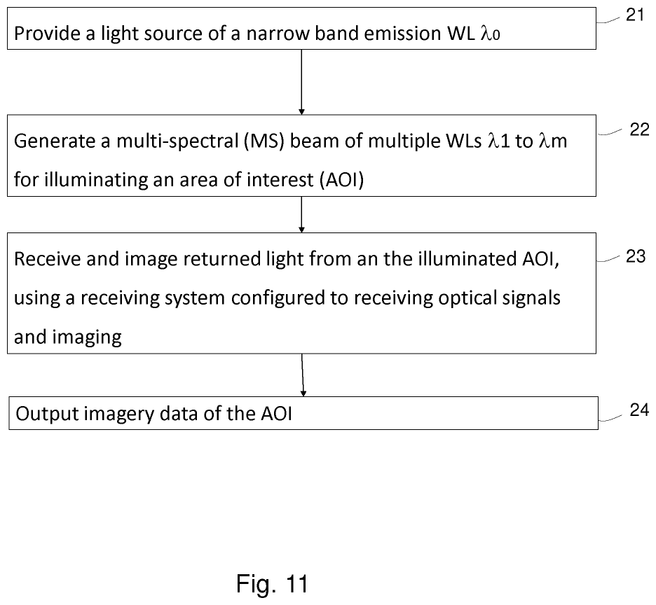

FIG. 11 is a flowchart, schematically illustrating main steps of a method for speckle suppression, using only spectral diversity, according to some embodiments. This method includes at least the following main steps:
providing a light source of a narrow (single) WL narrow bandwidth l₀ (step 21);
generating a MS beam including multiple WLs l₁ to lₙ (step 22), using one or more optical means, for illuminating an AOI; and
receiving and imaging returned light from the illuminated AOI, using a receiving system (step 23); and
outputting imagery data of the AOI (step 24) or part thereof.

### EXAMPLES

Example 1 is a suppression subsystem for reducing speckles in an imagery system, the suppression subsystem comprising:
an illumination setup comprising:
at least one light source, each light source being configured to emit light of a narrow wavelength bandwidth; and
a number of wavelength (WL) converters, each WL converter being configured to receive at least a portion of the light emitted by one of the at least one light source and convert spectral properties of the received at least portion of the light, wherein the WL converters are configured to form an array of “n” number of spectrally differentiated input beams; and
a spectral beam combining (SBC) setup configured for beam combining of the array of spectrally differentiated input beams emanating from the illumination setup, outputting a combined multispectral beam comprising multiple spectrally differentiated output beams propagated in parallel trajectories, wherein the suppression subsystem is configured to emit output light therefrom, for illuminating at least one surface of an area of interest (AOI) in a manner that causes speckle suppression and also mitigates spatial intensity distribution expansion affects caused due to the speckle suppression.

In example 2, the subject matter of example 1 may include, wherein the SBC setup comprises:
an array of “n” number of collimators;
an optical setup comprising at least one element having at least one diffractive surface, configured for causing each of the received array of “n” number of spectrally differentiated input beams to be at least twice diffracted for combining the spectrally differentiated optical beams; or
a multiplicity of dichroic mirrors, each dichroic mirror being located and configured to receive input beam of a different WL “lₖ”, where “k” is an index number between l to n, and reflect the specific receivable input beam of WL lₖ and transmit therethrough at least all previously transmitted and reflected beams of WLs l₁ to lₖ₋₁, outputting a combined multispectral (MS) beam including WLs l₁ to lₙ.

In example 3, the subject matter of any one or more of examples 1 to 2 may include, wherein each WL converter comprises an Optical Parametric Oscillator (OPO) and/or a Raman parametric WL converter.

In example 4, the subject matter of example 3 may include, wherein each OPO is configured to adjustably control WL of light being outputted thereby, based on temperature control.

In example 5, the subject matter of any one or more of examples 1 to 4 may include, wherein the suppression subsystem further comprises an angular diversity setup, configured and positioned to receive the generated combined multispectral beam from the SBC setup, and to form a multiplicity of virtual multispectral output sources formed over a virtual output surface, causing light from the multiplicity of virtual multispectral output sources to impinge the at least one surface of the AOI from different angles and at different wavelengths.

In example 6, the subject matter of example 5 may include, wherein the angular diversity setup comprises a guiding optical setup configured to directly or indirectly receive the combined multispectral beam from the SBC setup, and to form the set of virtual light sources, each virtual light source being steered to have a different angular propagation direction, outputting light of spectral and angular diversity.

In example 7, the subject matter of example 6 may include, wherein the angular diversity setup further comprises one or more of:
a projection optical setup configured and positioned to reduce spatial expansion of the light emanating from the guiding optical setup; and/or
an injection optical setup configured and positioned to receive the combined multispectral beam from the SBC setup, and to direct the received combined multispectral beam such as to pass through the guiding optical setup.

In example 8, the subject matter of example 7 may include, wherein the guiding optical setup comprises one of: a bar-type homogenizer guide element; or two lenslet arrays positioned in parallel and at a distance “d” from one another having mutual focal lengths.

In example 9, the subject matter of example 8 may include, wherein the bar-type homogenizer guide element has a rectangular or a trapezoid shape.

In example 10, the subject matter of example 8 may include, wherein the distance “d” between the two lenslet arrays corresponds to the mutual focal length of the lenslet arrays.

In example 11, the subject matter of any one or more of examples 7 to 10 may include, wherein the projection optical setup and/or the injection optical setup comprises one or more focusing and/or collimation lenses.

In example 12, the subject matter of any one or more of examples 1 to 11 may include, wherein the suppression subsystem further comprises an optical path length (OPL) adjustment setup, configured and positioned to reduce mutual coherency by causing changes between optical path lengths (OPLs) of each beam portion of the combined multispectral beam formed by the SBC setup.

In example 13, the subject matter of any one or more of examples 1 to 12 may include, wherein the at least one light source of the illumination setup comprises at least one of: a laser device, a light emitting diode, a laser element.

In example 14, the subject matter of example 13 may include, wherein the at least one light source is an intra cavity or extra cavity second harmonics generation type laser device, outputting pulsed laser light within a narrow wavelength band.

In example 15, the subject matter of example 14 may include, wherein the laser device is configured for outputting light within the visible wavelength band.

In example 16, the subject matter of any one or more of examples 14 to 15 may include, wherein the laser device is configured to output pulsed light of a pulse duration that is higher than 50 nano seconds (ns).

Example 17 is a method for reducing speckles in an imagery system, using a suppression subsystem the method comprising at least:
providing at least one light source, configured to emit light of a narrow wavelength bandwidth;
providing a number of WL converters, each WL converter being configured to convert spectral properties of received light;
at each WL converter:
receiving at least a portion of the light emitted by one of the at least one light source and converting spectral properties of the received at least portion of the light, wherein the WL converters are configured to form an array of “n” number of spectrally differentiated input beams;
receiving and beam combining of the array of spectrally differentiated input beams emanating from the WL converters, using a spectral beam combining (SBC) setup; and
outputting a combined multispectral beam comprising multiple spectrally differentiated output beams propagated in parallel trajectories, wherein the suppression subsystem is configured to emit output light therefrom, for illuminating at least one surface of an area of interest (AOI) in a manner that causes speckle suppression and also mitigates spatial intensity distribution expansion affects caused due to the speckle suppression.

In example 18, the subject matter of example 17 may include, wherein the SBC setup comprises:
an array of “n” number of collimators;
an optical setup comprising at least one element having at least one diffractive surface, configured for causing each of the received array of “n” number of spectrally differentiated input beams to be at least twice diffracted for combining the spectrally differentiated optical beams; or
a multiplicity of dichroic mirrors, each dichroic mirror being located and configured to receive input beam of a different WL “lₖ”, where “k” is an index number between l to n, reflect the specific WL lₖ of the received input beam and transmit therethrough at least all previously transmitted and reflected WLs l₁ to lₖ₋₁, outputting a combined MS beam including WLs l₁ to lₙ.

In example 19, the subject matter of any one or more of examples 17 to 18 may include, wherein each WL converter comprises an Optical Parametric Oscillator (OPO) and/or a Raman parametric WL converter.

In example 20, the subject matter of example 19 may include, wherein each OPO is configured to adjustably control WL of light being outputted thereby, based on temperature control.

In example 21, the subject matter of any one or more of examples 17 to 20 may include, wherein the method further comprises:
receiving, by an angular diversity setup, the generated combined multispectral beam from the SBC setup; and
forming a multiplicity of virtual multispectral output sources formed over a virtual output surface, causing light from the multiplicity of virtual multispectral output sources to impinge the at least one surface of the AOI from different angles and at different wavelengths.

In example 22, the subject matter of example 21 may include, wherein the angular diversity setup comprises a guiding optical setup configured to directly or indirectly receive the combined multispectral beam from the SBC setup and form the set of virtual light sources, each virtual light source being steered to have a different angular propagation direction, outputting light of spectral and angular diversity.

In example 23, the subject matter of example 22 may include, wherein the angular diversity setup further comprises one or more of:
a projection optical setup configured and positioned to reduce spatial expansion of the light emanating from the guiding optical setup; and/or
an injection optical setup configured and positioned to receive the combined multispectral beam from the SBC setup and direct the received combined multispectral beam such as to be passed through the guiding optical setup.

In example 24, the subject matter of example 23 may include, wherein the guiding optical setup comprises one of:
a bar-type homogenizer guide element; or
two lenslet arrays positioned in parallel and at a distance D from one another having mutual focal lengths.

In example 25, the subject matter of any one or more of examples 23 to 24 may include, wherein the projection optical setup and/or the injection optical setup comprises one or more focusing and/or collimation lenses.

In example 26, the subject matter of any one or more of examples 17 to 25 may include, wherein the method further comprises causing changes between optical path lengths (OPLs) of each beam portion of the at least one multispectral combined generated by the SBC setup, using an OPL adjustment setup, for reducing mutual coherency of the beam portions.

In example 27, the subject matter of any one or more of examples 17 to 26, wherein the at least one light source of the illumination setup comprises at least one of: a laser device, a light emitting diode, a laser element.

In example 28, the subject matter of example 27 may include, wherein the at least one light source is an intra cavity or extra cavity second harmonics generation type laser device, outputting pulsed laser light within a narrow wavelength band.

In example 29, the subject matter of example 28 may include, wherein the laser device is configured for outputting light within the visible wavelength band.

In example 30, the subject matter of any one or more of examples 28 to 29 may include, wherein the laser device is configured to output pulsed light of a pulse duration that is higher than 50 nano seconds (ns).

Unless specifically stated otherwise, as apparent from the above discussions, it is appreciated that throughout the specification discussions utilizing terms such as “obtaining”, “identifying”, “performing”, “providing” “moving”, “instructing”, “achieving”, receiving”, “analyzing”, “processing”, determining “, deducing” “calculating”, and the like, or any grammatical conjugation thereof, include one or more actions and/or processes of a computer and/or one or more processors that manipulate and/or transform data and/or signals into other data and/or signals, said data/signals represented as physical quantities, e.g., such as electronic quantities, and/or said data representing the physical objects. The terms “computer”, “processor”, “processing resource”, “processing circuitry”, and “controller” should be expansively construed to cover any kind of electronic device with data processing capabilities, including, by way of non-limiting example, a personal desktop/laptop computer, a server, a computing system, a communication device, a smartphone, a tablet computer, a smart television, a processor (e.g. digital signal processor (DSP), a microcontroller, a field programmable gate array (FPGA), an application specific integrated circuit (ASIC), etc.), a group of multiple physical machines sharing performance of various tasks, virtual servers co-residing on a single physical machine, any other electronic computing device, and/or any combination thereof.

As used herein, the phrase “for example,” “such as”, “for instance” and variants thereof describe non-limiting embodiments of the presently disclosed subject matter.

Reference in the specification to “one case”, “some cases”, “other cases” or variants thereof means that a particular feature, structure or characteristic described in connection with the embodiment(s) is included in at least one embodiment of the presently disclosed subject matter. Thus, the appearance of the phrase “one case”, “some cases”, “other cases” or variants thereof does not necessarily refer to the same embodiment(s).

It is appreciated that, unless specifically stated otherwise, certain features of the presently disclosed subject matter, which are, for clarity, described in the context of separate embodiments, may also be provided in combination in a single embodiment. Conversely, various features of the presently disclosed subject matter, which are, for brevity, described in the context of a single embodiment, may also be provided separately or in any suitable sub-combination.

Any reference in the specification to a method should be applied mutatis mutandis to a system capable of executing the method and should be applied mutatis mutandis to a non-transitory computer readable medium that stores instructions that once executed by a computer result in the execution of the method.

Any reference in the specification to a system should be applied mutatis mutandis to a method that may be executed by the system and should be applied mutatis mutandis to a non-transitory computer readable medium that stores instructions that may be executed by the system.

Any reference in the specification to a non-transitory computer readable medium should be applied mutatis mutandis to a system capable of executing the instructions stored in the non-transitory computer readable medium and should be applied mutatis mutandis to method that may be executed by a computer that reads the instructions stored in the non-transitory computer readable medium.

It is to be understood that the presently disclosed subject matter is not limited in its application to the details set forth in the description contained herein or illustrated in the drawings. The presently disclosed subject matter is capable of other embodiments and of being practiced and carried out in various ways. Hence, it is to be understood that the phraseology and terminology employed herein are for the purpose of description and should not be regarded as limiting. As such, those skilled in the art will appreciate that the conception upon which this disclosure is based may readily be utilized as a basis for designing other structures, methods, and systems for carrying out the several purposes of the present presently disclosed subject matter.

It will also be understood that the system according to the presently disclosed subject matter can be implemented, at least partly, as a suitably programmed computer. Likewise, the presently disclosed subject matter contemplates a computer program being readable by a computer for executing the disclosed method. The presently disclosed subject matter further contemplates a machine-readable memory tangibly embodying a program of instructions executable by the machine for executing the disclosed method.

1. A speckle suppression subsystem for reducing speckles in an imagery system, the speckle suppression subsystem comprising:
an illumination setup comprising:
at least one light source configured to emit light at a narrow wavelength bandwidth; and
a plurality of wavelength converters configured to receive at least a portion of light emitted by at least one of the at least one light source and convert spectral properties of the received portion of light, wherein the wavelength converters are configured to form an array of spectrally differentiated input beams; and
a spectral beam combining (SBC) setup configured to:
combine the array of spectrally differentiated input beams emanating from the illumination setup, and
output a combined multispectral beam comprising multiple spectrally differentiated output beams propagated in parallel trajectories;
wherein the speckle suppression subsystem is configured to illuminate at least one surface of an area of interest (AOI) with the combined multispectral beam to suppress speckle and mitigate spatial intensity distribution expansion affects.

2. The speckle suppression subsystem of claim 1, wherein the SBC setup comprises at least two diffractive surfaces configured to combine the array of spectrally differentiated input beams.

3. The speckle suppression subsystem of claim 1, wherein the SBC setup comprises a plurality of n dichroic mirrors, wherein each dichroic mirror k, with k ranging from l to n, is located and configured to:
receive an input beam k having a wavelength lₖ being one of the n spectrally differentiated input beams having different wavelengths l₁ to lₙ,
reflect the received input beam,
transmit at least the previous input beams l to k-l with wavelengths l₁ to lₖ₋₁; and wherein the n^{th} dichroic mirror is configured to output the combined multispectral beam including wavelengths l₁ to lₙ.

4. The speckle suppression subsystem of claim 1, wherein the wavelength converters comprise optical parametric oscillators (OPOs) and/or Raman parametric wavelength converters.

5. The speckle suppression subsystem of claim 4, wherein at least one of the wavelength converters comprises an OPO configured to adjustably control the wavelength of the light being outputted thereby, based on temperature control.

6. The speckle suppression subsystem of claim 1, further comprising an angular diversity setup, configured and positioned to receive the combined multispectral beam formed by the SBC setup, and to form a plurality of virtual multispectral output sources formed over a virtual output surface, causing light from the plurality of virtual multispectral output sources to impinge on the at least one surface of the AOI from different angles and at different wavelengths.

7. The speckle suppression subsystem of claim 6, wherein the angular diversity setup comprises a guiding optical setup configured to directly or indirectly receive the combined multispectral beam from the SBC setup, and to form the plurality of virtual multispectral output sources, each virtual light source being steered to have a different angular propagation direction, outputting light of spectral and angular diversity.

8. The speckle suppression subsystem of claim 7, wherein the angular diversity setup further comprises:
a projection optical setup configured and positioned to reduce spatial expansion of the light emanating from the guiding optical setup; and/or
an injection optical setup configured and positioned to receive the combined multispectral beam from the SBC setup, and to direct the received combined multispectral beam such as to pass through the guiding optical setup.

9. The speckle suppression subsystem of claim 7, wherein the guiding optical setup comprises a bar-type homogenizer guide element; or two lenslet arrays positioned in parallel and at a distance d from one another, having mutual focal length.

10. The speckle suppression subsystem of claim 9, wherein the guiding optical setup comprises the bar-type homogenizer guide element that has a rectangular or a trapezoid shape.

11. The speckle suppression subsystem of claim 9, wherein the guiding optical setup comprises the two lenslet arrays, and wherein the distance d corresponds to the mutual focal length.

12. The speckle suppression subsystem of claim 8, wherein the projection optical setup and/or the injection optical setup comprises one or more focusing and/or collimation lenses.

13. The speckle suppression subsystem of claim 1, further comprising an optical path length (OPL) adjustment setup, configured and positioned to reduce mutual coherency between the beams by causing changes between OPLs of the spectrally differentiated output beams.

14. The speckle suppression subsystem of claim 1, wherein the at least one light source of the illumination setup comprises at least one of: a laser device, a light emitting diode, and a laser element.

15. The speckle suppression subsystem of claim 14, wherein the at least one light source is an intra cavity or an extra cavity second harmonics generation type laser device, outputting pulsed laser light within a narrow wavelength band.

16. The speckle suppression subsystem of claim 15, wherein the laser device is configured for outputting light within the visible wavelength band.

17. The speckle suppression subsystem of claim 16, wherein the laser device is configured to output pulsed light of a pulse duration that is higher than 50 nano seconds (ns).

18. A method of reducing speckles in an imaging system, the method comprising:
generating an array of spectrally differentiated input beams by converting spectral properties of received light that has a narrow wavelength bandwidth, and
combining the beams of the generated array of spectrally differentiated input beams to yield a combined multispectral beam that comprises multiple spectrally differentiated output beams which propagate in parallel trajectories,
wherein the combined multispectral beam suppresses speckles and mitigates spatial intensity distribution expansion affects upon illuminating at least one surface of an area of interest (AOI) with the combined multispectral beam.

19. The method of claim 18, wherein combining the spectrally differentiated input beams is carried out by at least one of:
(i) at least two diffractive surfaces configured to combine the array of spectrally differentiated input beams;
(ii) a plurality of n dichroic mirrors, wherein each dichroic mirror k, with k ranging from l to n, is located and configured to: receive an input beam k having a wavelength lₖ being one of the n spectrally differentiated input beams having different wavelengths l₁ to lₙ, reflect the received input beam, and transmit at least the previous input beams l to k-l with wavelengths l₁ to lₖ₋₁; and wherein the n^{th} dichroic mirror is configured to output the combined multispectral beam including wavelengths l₁ to lₙ; and
(iii) optical parametric oscillators (OPOs) and/or Raman parametric wavelength converters, configured to adjustably control the wavelength of the light being outputted thereby, based on temperature control.

20. The method of claim 18, further comprising forming a plurality of virtual multispectral output sources over a virtual output surface, causing light from the plurality of virtual multispectral output sources to impinge the at least one surface of the AOI from different angles and at different wavelengths.
